(19) United States
(12) Patent Application Publication
(10) Pub. No.: US 2007/0284551 A1
(43) Pub. Date: Dec. 13, 2007

(54) Electromagnetically Driven Valve

(76) Inventors: Yutaka Sugie, Aichi-ken (JP); Masahiko Asano, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/660,382

(22) PCT Filed: Jun. 22, 2005
(86) PCT No.: PCT/JP05/11895

§ 371 Date: Feb. 16, 2007

(30) Foreign Application Priority Data
Aug. 19, 2004 (JP) 2004-239777

(51) Int. Cl. H01F 7/17

(52) U.S. Cl. 251/129.01

(57) ABSTRACT

An electromagnetically driven valve includes: a driven valve having a stem and carrying out reciprocating motion along a direction in which the stem extends; a lower disc and an upper disc spaced apart from each other and having one ends coupled to the stem so as to allow free oscillation of the disc and the other ends supported by a disc base so as to allow free oscillation of the disc respectively, and an electromagnet having first and second coils, arranged between the lower disc and the upper disc, and implementing a plurality of magnetic circuits. The electromagnetically driven valve attaining lower power consumption is thus provided.

### TECHNICAL FIELD

The present invention generally relates to an electromagnetically driven valve, and more particularly to an electromagnetically driven valve of a rotary drive type used in an internal combustion engine.

### BACKGROUND ART

As a conventional electromagnetically driven valve, for example, U.S. Pat. No. 6,467,441 specification discloses an electromagnetic actuator actuating valves of an internal combustion engine as a result of cooperation of electromagnetic force and a spring.

The electromagnetic actuator disclosed in U.S. Pat. No. 6,467,441 is called a rotary drive type, and includes a valve having a stem and an oscillating arm having a first end hinged on a support frame and a second end in abutment on the upper end of the stem.

### DISCLOSURE OF THE INVENTION

In the conventional electromagnetically driven valve, movable members have large mass. As large force is necessary for driving the movable members, power consumption has disadvantageously been large.

The present invention was made to solve the above-described problems, and an object of the present invention is to provide an electromagnetically driven valve attaining lower power consumption.

An electromagnetically driven valve according to one aspect of the present invention is actuated by cooperation of electromagnetic force and elastic force. The electromagnetically driven valve includes: a driven valve having a valve shaft and carrying out reciprocating motion along a direction in which the valve shaft extends; first and second oscillating members spaced apart from each other and each having one end coupled to the valve shaft so as to allow free oscillation of the oscillating member and the other end supported by a base member so as to allow free oscillation of the oscillating member; and an electromagnet having a coil, arranged between the first oscillating member and the second oscillating member, and implementing a plurality of magnetic circuits. The electromagnetic force is applied to the first and second oscillating members as a result of current flow through the coil.

According to the present invention, the electromagnet implements a plurality of magnetic circuits. Therefore, as compared with an example in which an electromagnet implements a single magnetic circuit, the plurality of magnetic circuits can act on the first and second oscillating members to drive the same. As the plurality of magnetic circuits act on the first and second oscillating members to drive the same, the force is applied to the first and second oscillating members in a distributed manner. As a result, even if the first and second oscillating members have smaller strength, breakage thereof is unlikely. Consequently, the mass of the first and second oscillating members can be made smaller, and lower power consumption can be attained.

Preferably, a plurality of coils are provided, and first and second coils implement the plurality of magnetic circuits.

Preferably, the first coil closer to one end has the number of turns smaller than the second coil closer to the other end.

Preferably, the first and second coils are connected in series.

Preferably, a single coil is provided, and the first coil implements first and second magnetic circuits.

An electromagnetically driven valve according to another aspect of the present invention is actuated by cooperation of electromagnetic force and elastic force. The electromagnetically driven valve includes: a driven valve having a valve shaft and carrying out reciprocating motion along a direction in which the valve shaft extends; first and second oscillating members spaced apart from each other and each having one end coupled to the valve shaft so as to allow free oscillation of the oscillating member and the other end supported by a base member so as to allow free oscillation of the oscillating member; and an electromagnet having a coil and arranged between the first oscillating member and the second oscillating member. The electromagnetic force is applied to the first and second oscillating members as a result of current flow through the coil, and the valve shaft is located between a central axis of the electromagnetic force generated by the electromagnet and the other end.

According to the electromagnetically driven valve structured as above, the valve shaft is located between the central axis of the electromagnetic force generated by the electromagnet and the other end. Accordingly, the electromagnetic force applied to the central axis of the electromagnetic force is amplified based on the principle of leverage, and the amplified force is applied to the valve shaft. Consequently, even if the current to be fed to the electromagnetic force is lowered, large force is generated and power consumption can be reduced.

An electromagnetically driven valve according to yet another aspect of the present invention is actuated by cooperation of electromagnetic force and elastic force. The electromagnetically driven valve includes: a driven valve capable of extension and contraction having a valve shaft and carrying out reciprocating motion along a direction in which the valve shaft extends; first and second oscillating members spaced apart from each other and each having one end coupled to the valve shaft so as to allow free oscillation of the oscillating member and the other end supported by a base member so as to allow free oscillation of the oscillating member; and an electromagnet having a coil and arranged between the first oscillating member and the second oscillating member. The electromagnetic force is applied to the first and second oscillating members as a result of current flow through the coil.

According to the electromagnetically driven valve structured as above, the valve shaft is capable of ex-tension and contraction. Accordingly, the first and second oscillating members can move to a position where they come in contact with the electromagnet, whereby maximum electromagnetic force can be obtained. Therefore, the electromagnetic force can be generated with a minimum current and reduction in power consumption can be attained.

According to the present invention, an electromagnetically driven valve attaining lower power consumption can be provided.

### BRIEF DESCRIPTION OF THE DRAWINGS

FIG. 1 is a cross-sectional view showing an electromagnetically driven valve according to Embodiment 1 of the present invention.

FIG. 2 is a perspective view showing a lower disc (an upper disc) in FIG. 1.

FIG. 3 is a perspective view showing an electromagnet in FIG. 1.

FIG. 4 is a schematic diagram showing the upper disc and the lower disc at a displacement end on a valve-opening side.

FIG. 5 is a schematic diagram showing the upper disc and the lower disc at an intermediate position.

FIG. 6 is a schematic diagram showing the upper disc and the lower disc at a displacement end on a valve-closing side.

FIG. 7 is a cross-sectional view of an electromagnet according to Embodiment 2 of the present invention.

FIG. 8 is a cross-sectional view of an electromagnet according to Embodiment 3 of the present invention.

FIG. 9 illustrates a circuit configuration of a comparative example.

FIG. 10 illustrates a circuit configuration according to Embodiment 3.

FIG. 11 is a cross-sectional view of an electromagnet according to Embodiment 4 of the present invention.

FIGS. 12 and 13 are cross-sectional views illustrating an operation of the electromagnet according to Embodiment 4 of the present invention.

FIG. 14 is a cross-sectional view of an electromagnetically driven valve according to Embodiment 5 of the present invention.

FIG. 15 is a cross-sectional view of an electromagnetically driven valve according to Embodiment 6 of the present invention.

FIGS. 16 to 20 illustrate examples of a stem.

### BEST MODES FOR CARRYING OUT THE INVENTION

Embodiments of the present invention will be described hereinafter with reference to the drawings. The same or corresponding elements have the same reference characters allotted, and detailed description thereof will not be repeated.

### Embodiment 1

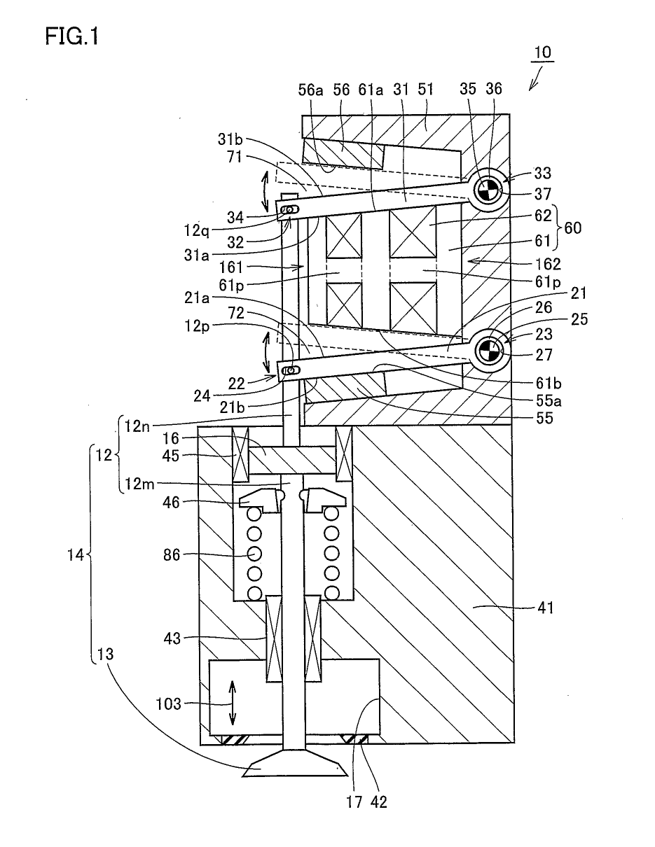

FIG. 1 is a cross-sectional view showing an electromagnetically driven valve according to Embodiment 1 of the present invention. The electromagnetically driven valve according to the present embodiment implements an engine valve (an intake valve or an exhaust valve) in an internal combustion engine such as a gasoline engine or a diesel engine. In the present embodiment, description will be given assuming that the electromagnetically driven valve implements an intake valve, however, it is noted that the electromagnetically driven valve is similarly structured also when it implements an exhaust valve.

Referring to FIG. 1, an electromagnetically driven valve 10 is a rotary drive type electromagnetically driven valve. As an operation mechanism for the electromagnetically driven valve, a parallel link mechanism is adopted. Electromagnetically driven valve 10 includes a driven valve 14 having a stem 12 extending in one direction, a lower disc 21 and an upper disc 31 coupled to different positions on stem 12 and oscillating by receiving electromagnetic force and elastic force applied thereto, a valve-opening/closing electromagnet 60 (hereinafter, also simply referred to as electromagnet 60) generating the electromagnetic force, and a lower spring 26 and an upper spring 36 having the elastic force. Driven valve 14 carries out reciprocating motion in the direction in which stem 12 extends (a direction shown with an arrow 103), upon receiving the oscillating movement of lower disc 21 and upper disc 31.

Driven valve 14 is mounted on a cylinder head 41 having an intake port 17 formed. A valve seat 42 is provided in a position where intake port 17 of cylinder head 41 communicates to a not-shown combustion chamber. Driven valve 14 further includes an umbrella-shaped portion 13 formed at an end of stem 12. The reciprocating motion of driven valve 14 causes umbrella-shaped portion 13 to intimately contact with valve seat 42 or to move away from valve seat 42, so as to open or close intake port 17. In other words, when stem 12 is elevated, driven valve 14 is positioned at a valve-closing position. On the other hand, when stem 12 is lowered, driven valve 14 is positioned at a valve-opening position.

Stem 12 is constituted of a lower stem 12m continuing from umbrella-shaped portion 13 and an upper stem 12n connected to lower stem 12m with a lash adjuster 16 being interposed. Lash adjuster 16 with a property more likely to contract and less likely to extend attains a function as a buffer member between upper stem 12n and lower stem 12m. Lower stem 12m has a coupling pin 12p projecting from its outer circumferential surface formed, and upper stem 12n has a coupling pin 12q projecting from its outer circumferential surface formed in a position away from coupling pin 12p.

In cylinder head 41, a valve guide 43 for slidably guiding lower stem 12m in an axial direction is provided, and a stem guide 45 for slidably guiding upper stem 12n in an axial direction is provided in a position away from valve guide 43. Valve guide 43 and stem guide 45 are formed from a metal material such as stainless steel, in order to endure high-speed slide movement with respect to stem 12.

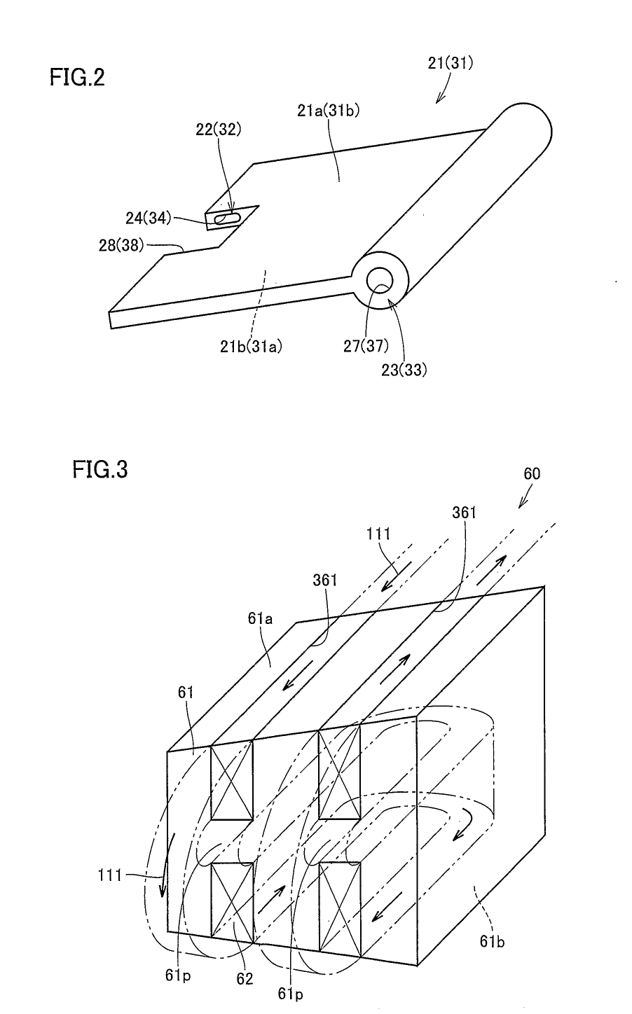

FIG. 2 is a perspective view showing the lower disc (the upper disc) in FIG. 1. Referring to FIGS. 1 and 2, lower disc 21 has one end 22 and the other end 23, and extends from one end 22 to the other end 23 in a direction intersecting stem 12. On a side of one end 22, lower disc 21 is formed like a flat plate having rectangular surfaces 21a, 21b. On a side of the other end 23, lower disc 21 is formed like a hollow cylinder having a hole 27 formed. Lower disc 21 has a notch 28 formed on the side of one end 22, and elongated holes 24 are formed in opposing wall surfaces of notch 28, respectively.

Upper disc 31 has a shape similar to lower disc 21, and one end 32, the other end 33, a surface 31b, a surface 31a, a hole 37, a notch 38, and an elongated hole 34 corresponding to one end 22, the other end 23, surface 21a, surface 21b, hole 27, notch 28, and elongated hole 24 of lower disc 21 respectively are formed. Lower disc 21 and upper disc 31 are formed from a soft magnetic material.

One end 22 of lower disc 21 is coupled to lower stem 12m so as to allow free oscillation (pivot) of the disc by insertion of coupling pin 12p into hole 27. One end 32 of upper disc 31 is coupled to upper stem 12n so as to allow free oscillation of the disc by insertion of coupling pin 12q into hole 37. A disc base 51 extending in parallel to stem 12 is provided on a top surface of cylinder head 41. The other end 23 of lower disc 21 is supported so as to allow free oscillation of the disc around a fulcrum 25 in disc base 51, while the other end 33 of upper disc 31 is supported so as to allow free oscillation of the disc around a fulcrum 35 in disc base 51. With such a structure, lower disc 21 and upper disc 31 oscillate (pivot) around fulcrums 25 and 35 serving as the center respectively, so as to cause driven valve 14 to reciprocate.

Lower spring 26 and upper spring 36 are provided at the other ends 23, 33, respectively. Lower spring 26 applies elastic force to lower disc 21, in a manner moving the same clockwise around fulcrum 25. Upper spring 36 applies elastic force to upper disc 31, in a manner moving the same counterclockwise around fulcrum 35. While the electromagnetic force from electromagnet 60 which will be described later is not yet applied, lower disc 21 and upper disc 31 are positioned by lower spring 26 and upper spring 36 at a position intermediate between a displacement end on a valve-opening side and a displacement end of a valve-closing side.

FIG. 3 is a perspective view showing the electromagnet in FIG. 1. Referring to FIGS. 1 and 3, electromagnet 60 is provided in disc base 51 at a position between lower disc 21 and upper disc 31. Electromagnet 60 is constituted of a valve-opening/closing coil 62 and a valve-opening/closing core 61 formed from a magnetic material and having attraction and contact surfaces 61a, 61b facing surface 31a of upper disc 31 and surface 21a of lower disc 21 respectively. Valve-opening/closing core 61 has a shaft portion 61p extending in a direction from one end to the other end of lower disc 21 or upper disc 31. Valve-opening/closing coil 62 is provided in a manner wound around shaft portion 61p, and implemented by a monocoil. Specifically, valve-opening/closing coil 62 is implemented by combination of a plurality of copper wires, however, the coil is not limited as such. As a material for implementing valve-opening/closing coil 62, a superconducting wire may also be employed.

Disc base 51 further includes a valve-opening permanent magnet 55, and a valve-closing permanent magnet 56 located on a side opposite to valve-opening permanent magnet 55 with electromagnet 60 being interposed. Valve-opening permanent magnet 55 has an attraction and contact surface 55a facing surface 21b of lower disc 21. A space 72 in which lower disc 21 oscillates is defined between attraction and contact surface 55a and attraction and contact surface 61b of electromagnet 60. In addition, valve-closing permanent magnet 56 has an attraction and contact surface 56a facing surface 31b of upper disc 31. A space 71 in which upper disc 31 oscillates is defined between attraction and contact surface 56a and attraction and contact surface 61a of electromagnet 60.

Valve-opening/closing core 61 is provided with a plurality of grooves 361, to which valve-opening/closing coil 62 is fitted. In FIG. 3, one coil is bent so that it is fitted to the plurality of grooves 361. The structure, however, is not limited as such, and a plurality of coils may be fitted to the grooves. Specifically, one coil may be wound in the groove on the right in FIG. 3, while another coil may be wound in the groove on the left. In addition, the number of turns is not particularly limited.

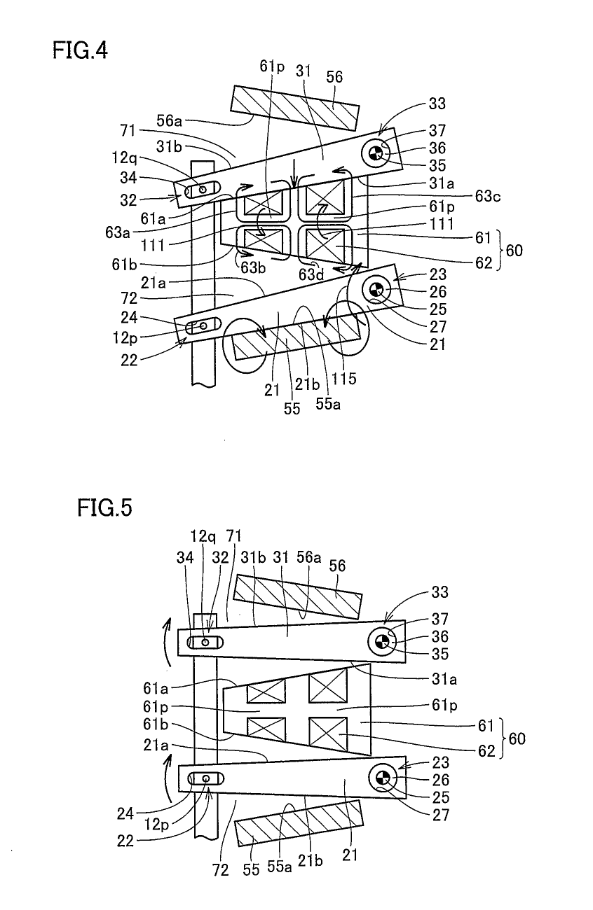

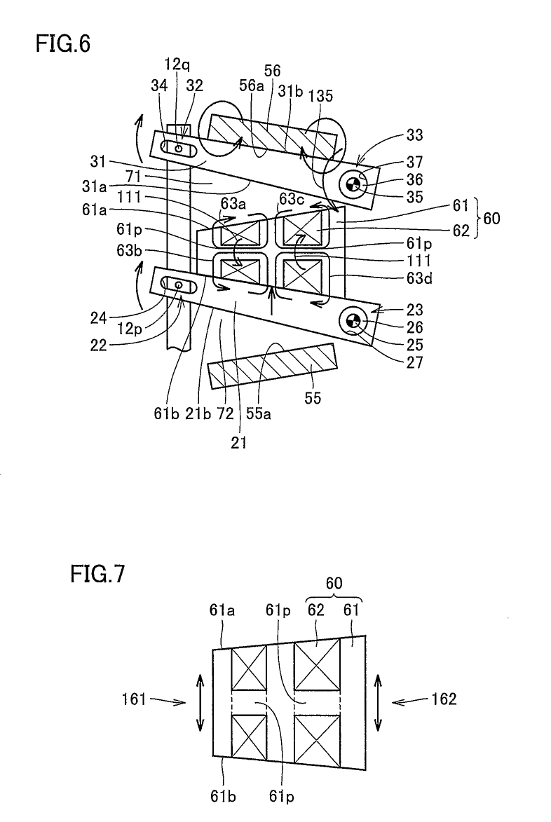

FIG. 4 is a schematic diagram showing the upper disc and the lower disc at the displacement end on the valve-opening side. FIG. 5 is a schematic diagram showing the upper disc and the lower disc at an intermediate position. FIG. 6 is a schematic diagram showing the upper disc and the lower disc at the displacement end on the valve-closing side. An operation of electromagnetically driven valve 10 will now be described.

Referring to FIG. 4, when driven valve 14 is at the valve-opening position, a current flows in valve-opening/closing coil 62 in a direction shown with an arrow 111 around shaft portion 61p of valve-opening/closing core 61. Here, magnetic flux flows in valve-opening/closing core 61 in a direction shown with an arrow, and magnetic circuits 63a, 63b, 63c, and 63d are generated. That is, electromagnetic force attracting upper disc 31 toward attraction and contact surface 61a of electromagnet 60 is generated. On the other hand, lower disc 21 is attracted to attraction and contact surface 55a by valve-opening permanent magnet 55. Consequently, upper disc 31 and lower disc 21 resist the elastic force of lower spring 26 arranged around fulcrum 25, and they are held at the displacement end on the valve-opening side shown in FIG. 4.

Referring to FIG. 5, when current supply to valve-opening/closing coil 62 is stopped, the electromagnetic force generated by electromagnet 60 disappears. Then, upper disc 31 and lower disc 21 move away from attraction and contact surfaces 61a, 55a as a result of the elastic force of lower spring 26 respectively, and start to oscillate toward the intermediate position. The elastic force applied by lower spring 26 and upper spring 36 attempts to hold upper disc 31 and lower disc 21 at the intermediate position. Therefore, at a position beyond the intermediate position, force in a direction reverse to an oscillating direction acts on upper disc 31 and lower disc 21 from upper spring 36. On the other hand, as inertial force acts on upper disc 31 and lower disc 21 in the oscillating direction, upper disc 31 and lower disc 21 oscillate as far as the position beyond the intermediate position.

Referring to FIG. 6, at the position beyond the intermediate position, a current is again fed to valve-opening/closing coil 62 in a direction shown with arrow 111. Here, on a side where lower disc 21 is located, lower disc 21 is attracted to electromagnet 60. On the other hand, upper disc 31 is attracted to attraction and contact surface 56a by valve-closing permanent magnet 56.

Here, upper disc 31 is also attracted to attraction and contact surface 61a of electromagnet 60 by the electromagnetic force generated by electromagnet 60. Here, the electromagnetic force is stronger between lower disc 21 and electromagnet 60 because a space therebetween is narrow. Therefore, upper disc 31 and lower disc 21 oscillate from the position beyond the intermediate position to the displacement end on the valve-closing side shown in FIG. 6.

Thereafter, current supply to valve-opening/closing coil 62 is repeatedly started and stopped at the timing described above. In this manner, upper disc 31 and lower disc 21 are caused to oscillate between the displacement ends on the valve-opening side and the valve-closing side, so that driven valve 14 carries out the reciprocating motion as a result of the oscillating movement.

Referring again to FIG. 1, in cylinder head 41, valve guide 43 for guiding lower stem 12m is provided. Lower stem 12m is held by a lower retainer 46, which comes in contact with a lower spring 86. Accordingly, lower spring 86 pushes lower retainer 46 upward. Lash adjuster 16 is attached to lower stem 12m. Lash adjuster 16 serves to accommodate registration error of driven valve 14 at the valve-closing position, as well as to bring umbrella-shaped portion 13 into contact with valve seat 42 in an ensured manner. In the present embodiment, the parallel link mechanism causing lower disc 21 and upper disc 31 to simultaneously oscillate in order to allow reciprocating motion of driven valve 14 is adopted. Actually, however, registration error of driven valve 14 tends to occur due to dimension error or assembly error caused among disc parts. Therefore, providing lash adjuster 16 is particularly effective in electromagnetically driven valve 10 including the parallel link mechanism.

Electromagnetically driven valve 10 according to Embodiment 1 is actuated by cooperation of the electromagnetic force and the elastic force. Electromagnetically driven valve 10 includes driven valve 14 having stem 12 serving as the valve shaft and carrying out the reciprocating motion along the direction in which stem 12 extends, lower disc 21 and upper disc 31 serving as the first and second oscillating members spaced apart from each other and having one ends 22, 32 coupled to stem 12 so as to allow free oscillation of the disc and the other ends 23, 33 supported by disc base 51 serving as the base member so as to allow free oscillation of the disc respectively, and electromagnet 60 having first and second coils 161, 162, arranged between lower disc 21 and upper disc 31, and implementing a plurality of magnetic circuits 63a, 63b, 63c, and 63d. When a current flows through first and second coils 161, 162, the electromagnetic force acts on lower disc 21 and upper disc 31.

As described above, as shown in FIGS. 4 and 6, in electromagnetically driven valve 10 according to the present invention, first coil 161 and second coil 162 generate magnetic circuits 63a, 63b, 63c, and 63d around themselves. Magnetic circuits 63a and 63b are generated by first coil 161, while magnetic circuits 63c and 63d are generated by second coil 162. When a plurality of magnetic circuits are generated by means of a plurality of coils, each magnetic circuit attracts upper disc 31. As attraction force is uniformly applied to upper disc 31, upper disc 31 will not break even if upper disc 31 has a smaller thickness. Similarly, as lower disc 21 is attracted to a plurality of magnetic circuits 63b and 63d, lower disc 21 is attracted to electromagnet 60 by uniform force. As a result, even if lower disc 21 has a smaller thickness, breakage of lower disc 21 is unlikely. Consequently, lower disc 21 and upper disc 31 can have smaller mass, and light weight of the movable portion can be achieved. Reduction in power consumption can thus effectively be attained.

According to the present invention, in the structure adopting the parallel link mechanism in the actuator of the electromagnetically driven valve, two or more coils are vertically provided. Accordingly, the number of magnetic circuits can be twice as many as the number of coils, whereby larger electromagnetic force is obtained.

### Embodiment 2

FIG. 7 is a cross-sectional view of an electromagnet according to Embodiment 2 of the present invention. In Embodiment 2, two or more coils having different number of turns respectively are arranged, in order to achieve improvement in response to electric power and larger electromagnetic force at the time of drive, so as to realize both operation stability and lower power consumption. In other words, in Embodiment 2, as shown in FIG. 7, first coil 161 having smaller number of turns and second coil 162 having larger number of turns are provided. Second coil 162 is located on a side closer to fulcrums 25, 35, while first coil 161 is located on a side remote from fulcrums 25, 35. First coil 161 and second coil 162 are connected to different circuits, so that the current can be controlled independently. A coil other than the first and second coils may be provided, and the number of turns or arrangement of that coil is not limited.

The electromagnetic force inversely relates to the response to the electromagnetic force. That is, as the number of turns of the coil is larger, the electromagnetic force is larger while response to the electromagnetic force is deteriorated. In contrast, if the number of turns of the coil is small, response to the electromagnetic force is improved while the electromagnetic force becomes smaller. In order to improve both of such characteristics that are contradictory, in Embodiment 2, for the purpose of improving controllability, the number of turns of first coil 161 located on a side remote from fulcrums 25, 35 to which large electromagnetic force is applied is decreased, so as to improve response to the electromagnetic force. In contrast, in order to increase the electromagnetic force when a gap is wide, the number of turns of second coil 162 located on a side closer to fulcrums 25, 35 is increased, so as to improve the electromagnetic force.

According to the electromagnetically driven valve in Embodiment 2 structured as above, an effect similar to that in Embodiment 1 can also be obtained.

### Embodiment 3

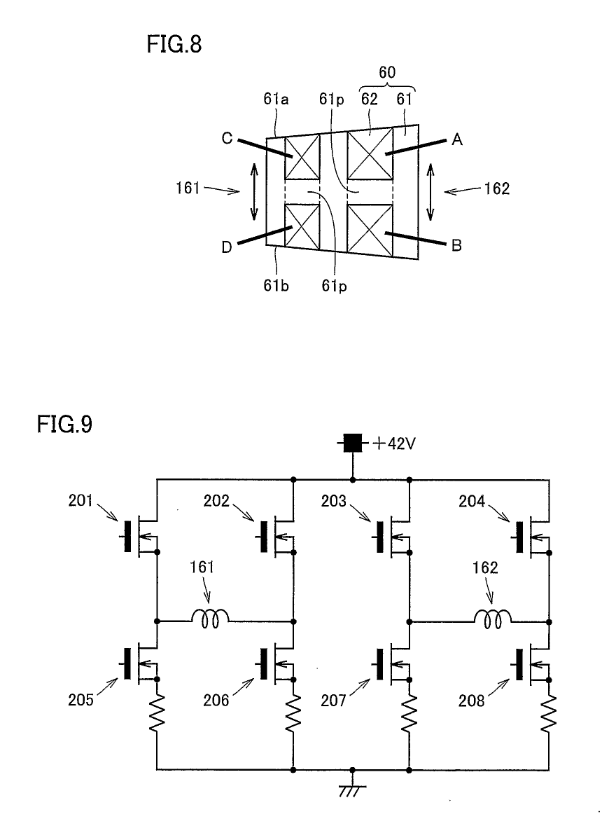

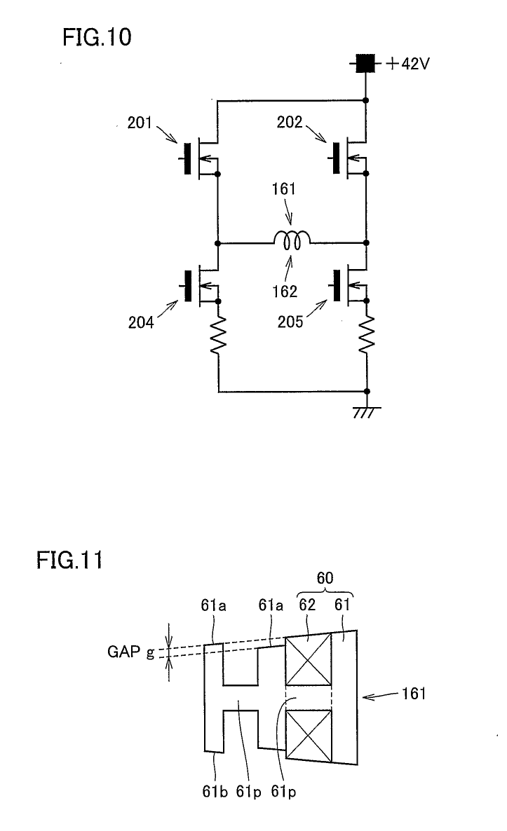

FIG. 8 is a cross-sectional view of an electromagnet according to Embodiment 3 of the present invention. FIG. 9 illustrates a circuit configuration of a comparative example. FIG. 10 illustrates a circuit configuration according to Embodiment 3.

Referring to FIGS. 8 and 10, in electromagnet 60 according to Embodiment 3 of the present invention, two or more coils having different number of turns respectively are connected in series, so as to implement a monocoil. As such, improvement in both of response to electric power and larger electromagnetic force at the time of drive is achieved, so as to realize operation stability, lower power consumption, and lower cost of a drive circuit. Specifically, as shown in FIG. 8, a starting and a terminating end of each coil, for example, point A and point C in FIG. 8, are connected to each other. Alternatively, two or more coils are continuously wound at the time of winding, so as to implement a monocoil. When the number of turns is set taking into account the electromagnetic force and response to electric power, the monocoil can attain the effect as shown in Embodiment 2. In addition, the number of circuit elements can be reduced, whereby simplification and lower cost of the circuit can be achieved.

Specifically, as shown in FIG. 9, when first coil 161 and second coil 162 are connected in parallel, eight transistors (field effect transistors) 201 to 208 for controlling an operation of the coils are necessary. In contrast, as shown in FIG. 10, when a monocoil is implemented, four transistors can control the operation of the coils. That is, the number of transistors in driving one electromagnet can be reduced to half, and consequently, the cost for the transistors can be reduced to half. Accordingly, significant cost reduction can be achieved.

### Embodiment 4

FIG. 11 is a cross-sectional view of an electromagnet according to Embodiment 4 of the present invention. In the electromagnet according to Embodiment 4, a bypass for a magnetic circuit is provided, so as to reduce a current at the time of drive as well as power consumption. As shown in FIG. 11, a gap g is provided above attraction and contact surface 61a of valve-opening/closing core 61. That is, attraction and contact surface 61a located in a central portion is lower than other portions.

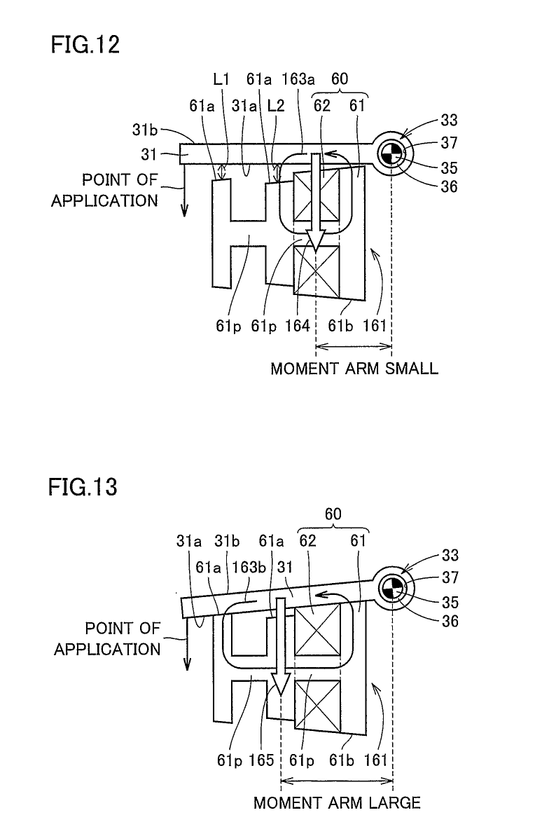

FIGS. 12 and 13 are cross-sectional views illustrating an operation of the electromagnet according to Embodiment 4 of the present invention. As shown in FIG. 12, in a neutral state, a distance between outer attraction and contact surface 61a and surface 31a is denoted by L1, while a distance between central attraction and contact surface 61a and surface 31a is denoted by L2. Here, L2 is smaller than L1. Accordingly, a magnetic circuit 163a passing through a portion of distance L2 is generated. The electromagnetic force passing through the center of magnetic circuit 163a as shown with an arrow 164 is applied to upper disc 31.

As shown in FIG. 13, when the valve opens, upper disc 31 approaches valve-opening/closing core 61. Accordingly, outer attraction and contact surface 61a comes in contact with surface 31a. In such a state, a large magnetic circuit 163b is generated, and the electromagnetic force passing through the center of that circuit as shown with an arrow 165 is generated.

In the present embodiment, a magnetic bypass is provided in valve-opening/closing core 61. In Embodiment 4, first coil 161 implements magnetic circuits 163a, 163b serving as first and second magnetic circuits. In this manner, in the neutral state shown in FIG. 12, the electromagnetic force is generated in the vicinity of fulcrum 35 where the gap between the fulcrum and upper disc 31 is narrow, which in turn acts as the attraction force. When the valve opens and closes, magnetic flux flows on a bypass side, and a state in which lever ratio is large can be retained. Therefore, the current and power consumption can be reduced.

### Embodiment 5

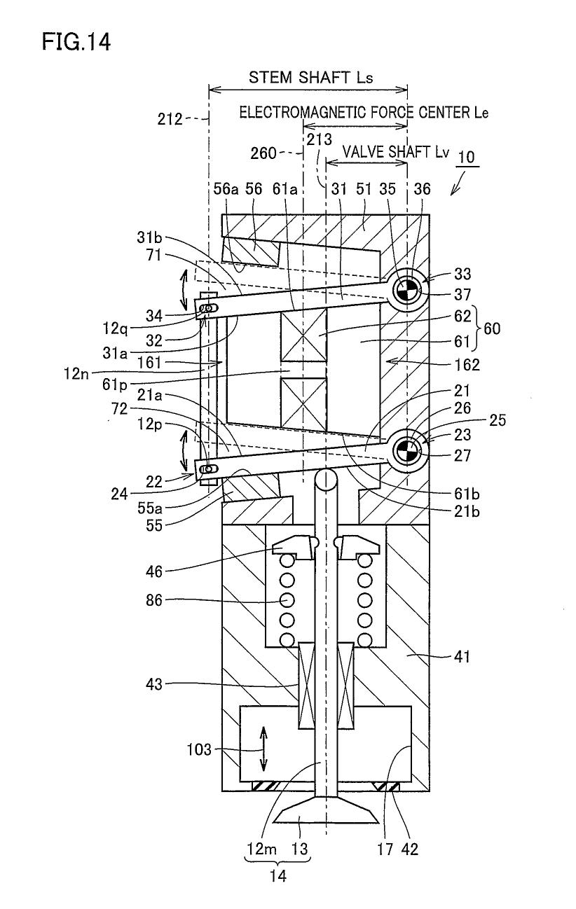

FIG. 14 is a cross-sectional view of an electromagnetically driven valve according to Embodiment 5 of the present invention. Referring to FIG. 14, in electromagnetically driven valve 10 according to Embodiment 5 of the present invention, a central axis 213 of the valve is offset, so as to optimize the lever ratio. Specifically, central axis 213 is provided between a central axis 260 of first coil 161 and the other ends 23, 33. A distance from fulcrums 25, 35 to central axis 213 is denoted by Lv, a distance from central axis 260 of first coil 161 to fulcrums 25, 35 is denoted by Le, and a distance from upper stem 12n to fulcrums 25, 35 is denoted by Ls. Here, a relation between force Fv required in the valve and electromagnetic force Fe is as follows.
Fv×Lv<Fe×Le

This equation can be modified as follows.
Fe>Fv×(Lv/Le)

Here, influence from the permanent magnet is not considered. That is, when a valve position is adjusted so as to attain a relation of Lv<Le, required electromagnetic force Fe becomes smaller. Therefore, the current for generating electromagnetic force Fe as well as power consumption can be reduced.

Though the structure employing first coil 161 alone has been shown in the present embodiment, the structure is not limited thereto. First coil 161 and second coil 162 may be employed.

Electromagnetically driven valve 10 according to the present embodiment is actuated by cooperation of the electromagnetic force and the elastic force. Electromagnetically driven valve 10 includes driven valve 14 having lower stem 12m serving as the valve shaft and carrying out the reciprocating motion along the direction in which lower stem 12m extends, lower disc 21 and upper disc 31 serving as the first and second oscillating members that are spaced apart from each other, oscillate correspondingly to each other, and have the end portions supported by disc base 51 so as to allow free oscillation of the disc respectively, and electromagnet 60 having first coil 161 and arranged between lower disc 21 and upper disc 31. When a current flows through first coil 161, the electromagnetic force acts on lower disc 21 and upper disc 31, and central axis 213 is located between central axis 260 of the electromagnetic force by the electromagnet and the other ends 23, 33.

### Embodiment 6

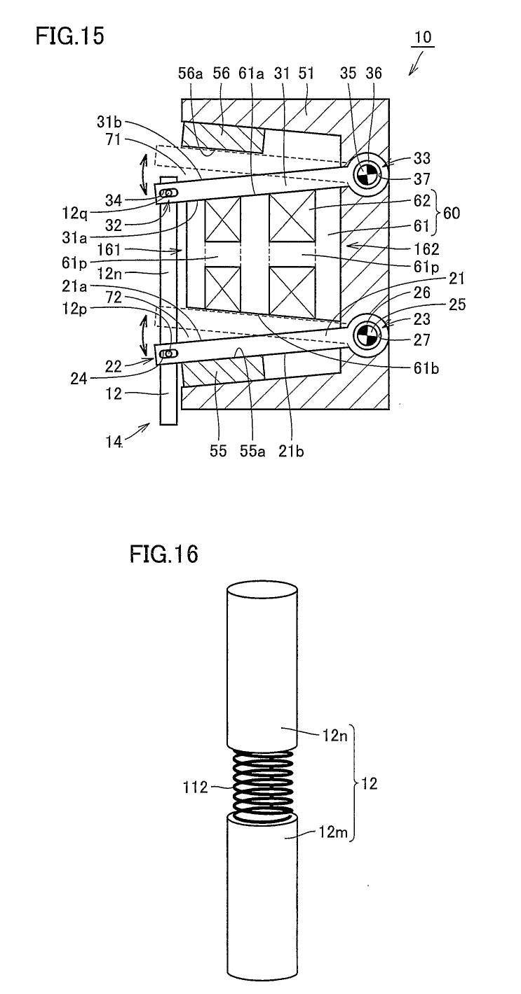

FIG. 15 is a cross-sectional view of an electromagnetically driven valve according to Embodiment 6 of the present invention. Referring to FIG. 15, in electromagnetically driven valve 10 according to Embodiment 6 of the present invention, stem 12 is implemented by a flexible arm. That is, the flexible arm is used for a portion where two discs are coupled, so that each of upper disc 31 and lower disc 21 can move to a position where a gap is no longer present. Large force can thus be generated, and power consumption is lowered.

Specifically, when upper stem 12n made of a rigid body connects lower disc 21 and upper disc 31 to each other, upper disc 31 and lower disc 21 abut on electromagnet 60 or either valve-opening permanent magnet 55 or valve-closing permanent magnet 56. Here, a gap is created where abutment was not made, in which case maximum electromagnetic force cannot be obtained. According to the present invention, as shown in FIG. 15, upper stem 12n is implemented by an arm flexible in an up-down direction (an arm capable of slight extension and- contraction), so that upper disc 31 and lower disc 21 can move to a position where they can contact a target member in an ensured manner, whereby maximum electromagnetic force can be obtained.

Therefore, the electromagnetic force can be generated with a minimum current and reduction in power consumption can be attained.

Electromagnetically driven valve 10 according to the present invention is actuated by cooperation of the electromagnetic force and the elastic force. Electromagnetically driven valve 10 includes driven valve 14 having stem 12 serving as the valve shaft capable of extension and contraction and carrying out the reciprocating motion along the direction in which stem 12 extends, lower disc 21 and upper disc 31 serving as the first and second oscillating members spaced apart from each other and having one ends 22, 32 coupled to stem 12 so as to allow free oscillation of the disc and the other ends 23, 33 supported by disc base 51 serving as the base member so as to allow free oscillation of the disc respectively, and electromagnet 60 having first and second coils 161, 162 and arranged between lower disc 21 and upper disc 31. When a current flows through first and second coils 161, 162, the electromagnetic force acts on lower disc 21 and upper disc 31 serving as the first and second oscillating members.

Upper stem 12n is implemented by the flexible arm, so that slight extension and contraction in a direction of its reciprocating motion is allowed.

FIGS. 16 to 20 illustrate examples of a stem. Referring to FIG. 16, stem 12 may be divided into upper stem 12n and lower stem 12m, and a spring 112 may be provided therebetween. Spring 112 connects upper stem 12n and lower stem 12m to each other, and can adjust a distance between upper stem 12n and lower stem 12m. Upper stem 12n and lower stem 12m are both made from a metal material. Upper stem 12n is connected to upper disc 31, while lower stem 12m is connected to lower disc 21. A lash adjuster or an elastic body may be inserted, instead of spring 112.

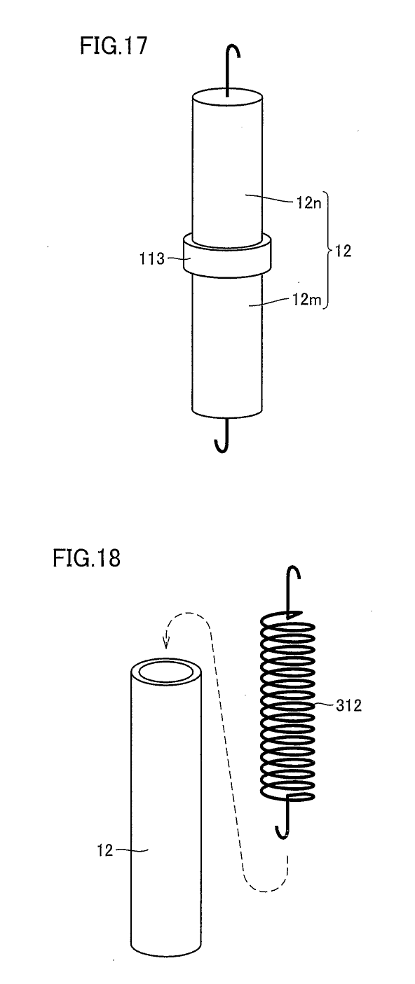

Referring to FIG. 17, an elastic body such as rubber or resin or a damper may be inserted between upper stem 12n and lower stem 12m. Such a contracting body 113 can contract when compressive force is applied. Here, upper stem 12n and lower stem 12m are connected to upper disc 31 and lower disc 21 respectively as described above. Contracting body 113 serving as an elastic member can be implemented by rubber or the like. A damper may alternatively be employed.

Referring to FIG. 18, stem 12 may be shaped like a hollow cylinder, in which a coil 312 may be fitted. Rigidity is set based on a spring constant of coil 312. Coil 312 has one end connected to the upper disc and the other end connected to the lower disc.

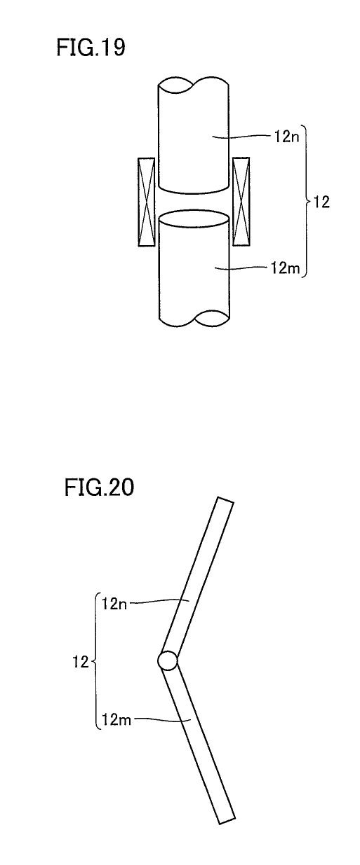

As shown in FIG. 19, the stem may be divided into upper stem 12n and lower stem 12m, and a clearance may be provided therebetween. Around the clearance, a guide for registration of the upper and lower stems is provided. In addition, as shown in FIG. 20, the stem may be bent at a portion between upper stem 12n and lower stem 12m.

Although the present invention has been described and illustrated in detail, it is clearly understood that the same is by way of illustration and example only and is not to be taken by way of limitation, the spirit and scope of the present invention being limited only by the terms of the appended claims.

### INDUSTRIAL APPLICABILITY

The present invention may be used in the field of the electromagnetically driven valve mounted on a vehicle.

1. An electromagnetically driven valve actuated by cooperation of an electromagnetic force and an elastic force, comprising:
a driven valve having a valve shaft and carrying out reciprocating motion along a direction in which said valve shaft extends;
first and second oscillating members spaced apart from each other and each having one end coupled to said valve shaft so as to allow free oscillation of the oscillating member and another end supported by a base member so as to allow free oscillation of the oscillating member; and
an electromagnet having a plurality of coils arranged between said first oscillating member and said second oscillating member, and implementing a plurality of magnetic circuits; wherein
said electromagnetic force is applied to said first and second oscillating members as a result of current flow through said coil;
said plurality of said coils include first and second coils, and
said first and second coils implement the plurality of magnetic circuits.

2. (canceled)

3. The electromagnetically driven valve according to claim 1, wherein
said first coil is closer to the one end has turns smaller in number than said second coil, which is closer to the other end.

4. The electromagnetically driven valve according to claim 1, wherein
said first and second coils are connected in series.

5. The electromagnetically driven valve according to claim 1, wherein
a single coil including said first coil is provided, a plurality of magnetic circuits include first and second magnetic circuits and said first coil implements said first and second magnetic circuits.

6. An electromagnetically driven valve actuated by cooperation of electromagnetic force and elastic force, comprising:
a driven valve having a valve shaft and carrying out a reciprocating motion along a direction in which said valve shaft extends;
first and second oscillating members spaced apart from each other, and each having one end coupled to said valve shaft so as to allow free oscillation of the oscillating member and another end supported by a base member so as to allow free oscillation of the oscillating member; and
an electromagnet having a coil, arranged between said first oscillating member and said second oscillating member; wherein
said electromagnetic force is applied to said first and second oscillating members as a result of current flow through said coil, and said valve shaft is located between a central axis of the electromagnetic force by the electromagnet and the other end.

7. An electromagnetically driven valve actuated by cooperation of an electromagnetic force and an elastic force, comprising:
a driven valve capable of extension and contraction having a valve shaft including an upper stem, a lower stem, and an elastic body provided therebetween, carrying out reciprocating motion along a direction in which said valve shaft extends;
first and second oscillating members spaced apart from each other, each oscillating member having one end coupled to said valve shaft so as to allow free oscillation of the oscillating member and another end supported by a base member so as to allow free oscillation of the oscillating member; and
an electromagnet having a coil arranged between said first oscillating member and said second oscillating member; wherein
said electromagnetic force is applied to said first and second oscillating members as a result of current flow through said coil.
